(19) United States
(12) Patent Application Publication
(10) Pub. No.: US 2009/0066873 A1
(43) Pub. Date: Mar. 12, 2009

(54) LCD Display with LED Backlight Optimized for Minimum Notebook Computer Dimensions

(76) Inventors: Reynold Li Liao, Austin, TX (US); Sean P. O'Neal, Round Rock, TX (US); Eugen Munteanu, Austin, TX (US); Andrew T. Sultenfuss, Leander, TX (US); Stefan Peana, San Diego, CA (US); Kevin Mundt, Austin, TX (US)

Correspondence Address: HAMILTON & TERRILE, LLP, P.O. BOX 203518, AUSTIN, TX, 78720, US

(21) Appl. No.: 11/853,911

(22) Filed: Sep. 12, 2007

(51) Int. Cl. G02F 1/1333

(52) U.S. Cl. 349/58

(57) ABSTRACT

A system and method that allows a LED driver board to both traverse the full width of the LCD glass and not occupy the volume occupied by hinges of the notebook information handling system. By providing an LCD display assembly that includes an LED backlight illumination system, the LED driver board for a panel may be moved to the bottom side of a display assembly.

### BACKGROUND OF THE INVENTION

1. Field of the Invention

The present invention relates to information handling systems and more particularly to information handling systems that comprise a liquid crystal display (LCD) with light-emitting diode (LED) backlight.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide portable information handling systems (such as notebook information handling systems) with LCD type displays. LCD type displays include LCD panels that utilize an illumination system that is known as a backlight illumination system. With known LCD panels, the backlight illumination system is via a cold cathode fluorescent lamps (CCFL) bulb. Certain LCD panels are now using LEDs for backlight illumination. With known LCD panels that use LEDs for backlight illumination, a driver board for the LCD backlight assembly traverses the entire width of the LCD glass to allow flexible circuits to connect to the glass.

Known notebook display assemblies include a chassis, an LCD panel, an LED driver board, and hinges to connect the display assembly to the base of the notebook information handling system. The hinges are generally positioned in the bottom left and right corners of the display assembly. One issue relating to known LED driver boards is that to minimize the thickness of an LCD assembly, the driver board is often positioned below the glass panel (see e.g., FIGS. 1A and 1B, labeled Prior Art).

In known information handling systems, the driver board and the hinges are often positioned in the same location. Either to rectify interference of the driver board and the hinges, the system can be made larger in the Y-dimension or the driver board can be placed behind the glass panel (see e.g., FIGS. 2A and 2B, labeled Prior Art). The result of placing the driver board (which is populated with components for driving the LED backlight illumination system) behind the panel is that the Z-dimension of the display assembly is increased (e.g., by about 3 mm in the location of the driver board).

Accordingly, it is desirable to provide a method that allows a LED driver board to both traverse the full width of the LCD glass and not occupy the volume occupied by the hinges.

### SUMMARY OF THE INVENTION

In accordance with the present invention a system and method that allows a LED driver board to both traverse the full width of the LCD glass and not occupy the volume occupied by the hinges is set forth. More specifically, by providing an LCD type display that includes an LED backlight illumination system, the LED driver board for a panel may be moved to the bottom side of a display assembly.

In one embodiment, the invention relates to an information handling system display assembly includes a display panel having a width, a display board assembly coupled to the processor and the display panel. The display board assembly includes a display board assembly coupled to the display panel on a display panel side of the display board and the display board has a wider portion extending the substantially width of the display panel and a narrow portion extending less than the width of the display panel, and a display component mounted on the display panel side of the display board.

In another embodiment, the invention relates to an information handling system display assembly that includes a processor, memory coupled to the processor, and a display assembly. The display assembly includes a display panel having a width, a display board assembly coupled to the processor and the display panel. The display board assembly includes a display board assembly coupled to the display panel on a display panel side of the display board and the display board has a wider portion extending the substantially width of the display panel and a narrow portion extending less than the width of the display panel, and a display component mounted on the display panel side of the display board.

### BRIEF DESCRIPTION OF THE DRAWINGS

The present invention may be better understood, and its numerous objects, features, and advantages made apparent to those skilled in the art by referencing the accompanying drawings. The use of the same reference number throughout the several figures designates a like or similar element.

FIGS. 1A and 1B, labeled Prior Art, show a perspective view and a cross sectional view of a display driver printed circuit board positioned below an LCD panel.

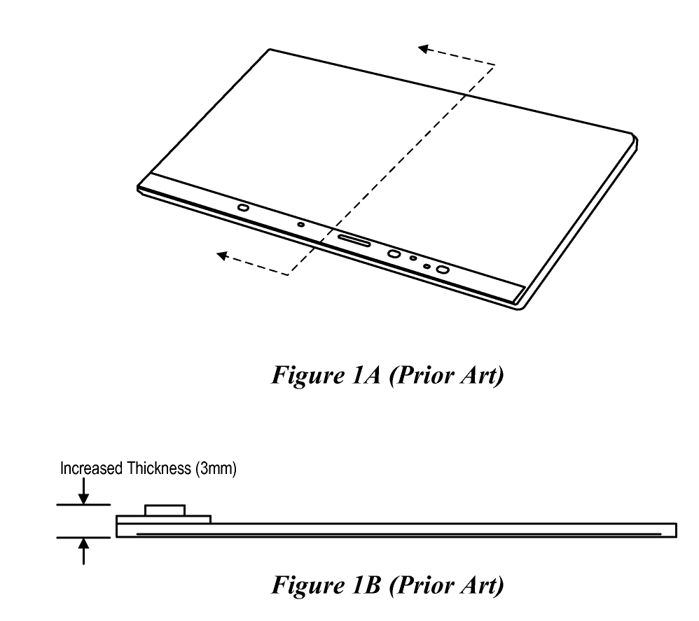

FIGS. 2A and 2B, labeled Prior Art, show a perspective view and a cross sectional view of a display driver printed circuit board layered with an LCD panel.

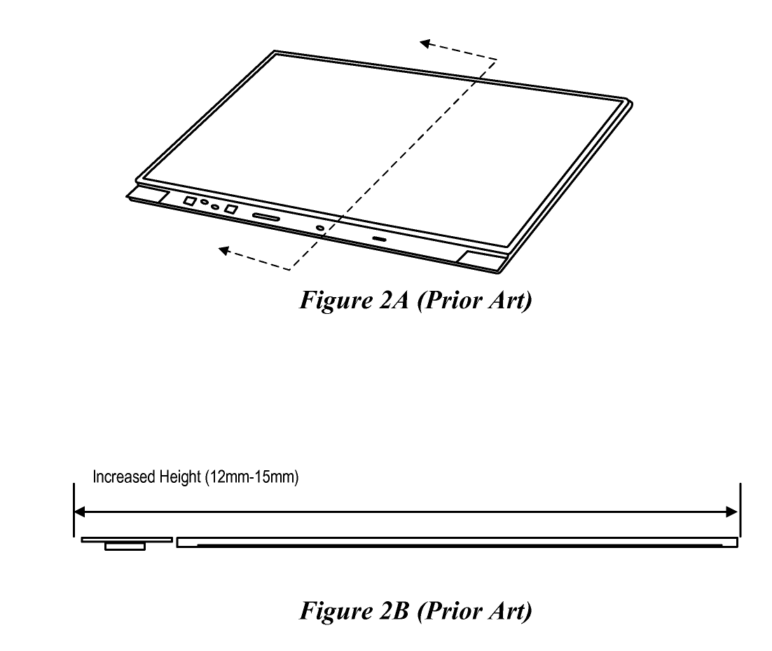

FIG. 3 shows a system block diagram of an information handling system.

FIG. 4 shows a front perspective view of an LCD panel assembly.

FIG. 5 shows a rear perspective view of an LCD panel assembly.

FIG. 6 shows a cross section view of an LCD panel assembly.

FIG. 7 shows a perspective view of an LCD panel assembly including a wire channel.

### DETAILED DESCRIPTION

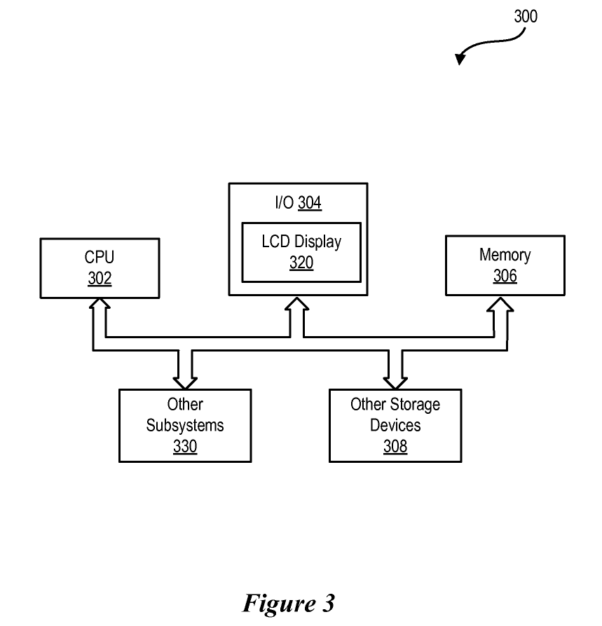

Referring briefly to FIG. 3, a system block diagram of an information handling system 300 is shown. The information handling system 300 includes a processor 302, input/output (I/O) devices 304, such as a display, a keyboard, a mouse, and associated controllers, memory 306, including volatile memory such as random access memory (RAM) and non-volatile memory such as read only memory (ROM) and hard disk drives, and other storage devices 308, such as an optical disk and drive, and various other subsystems 310, all interconnected via one or more buses 312. The I/O devices 304 include an LCD display device 320

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

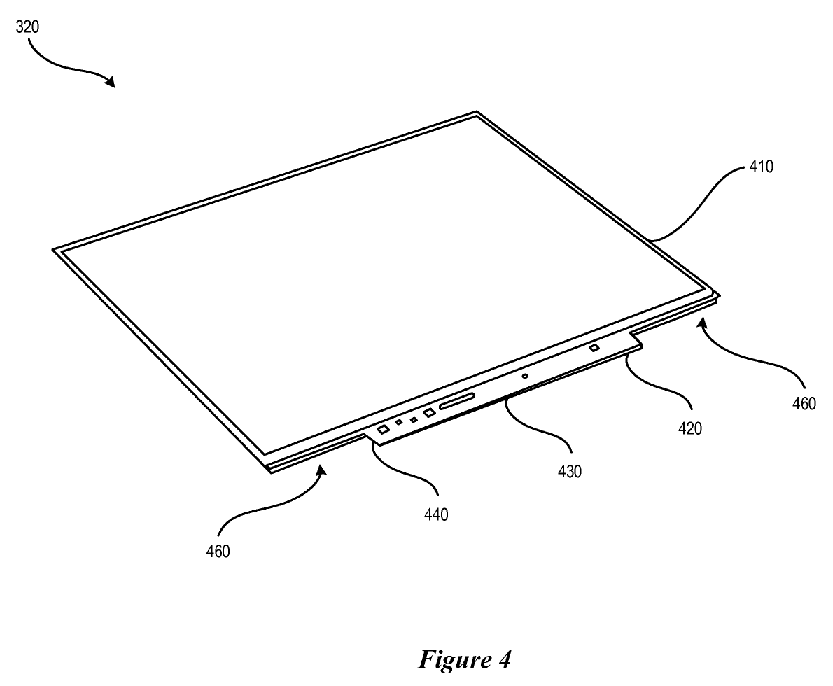

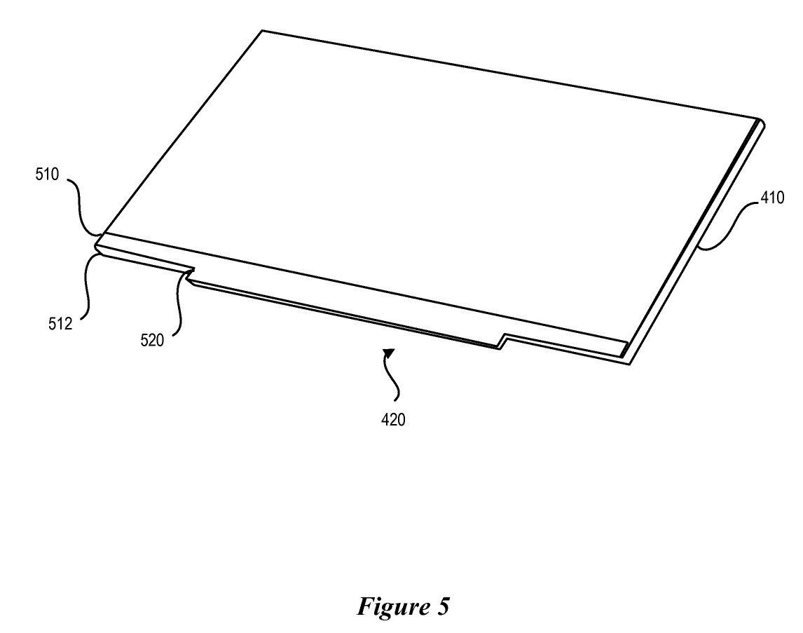

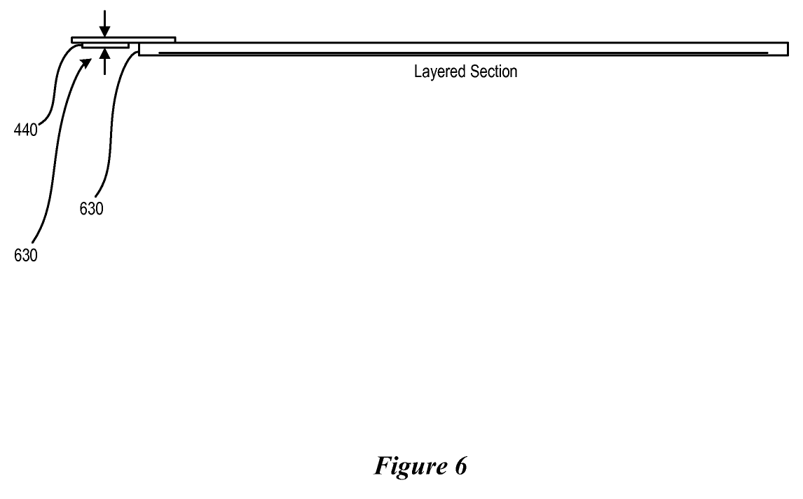

Referring to FIGS. 4-6, the LCD display device 320 includes an LCD panel 410 as well as a driver board assembly 420. The driver board assembly 420 includes an LED driver board 430 (which may be a printed circuit board) as well as components 440 mounted to the driver board 430.

The LED driver board 430 is a thickness of, e.g., approximately 0.8 mm. When components 610 are mounted on the LED driver board 430, the total thickness of the driver board assembly 420 is, e.g., approximately 3.0 mm.

The LED driver board 430 is configured in a T shape. The wide portion 510 of the T of the LED driver board 430 (i.e., the top of the T) traverses the width of the LCD panel 410. The under side 512 of the T cross bar is substantially flush with the bottom edge 620 of the glass of the LCD panel 410. The vertical portion 520 of the T (i.e., the base of the T) of the LED driver board protrudes below the bottom edge 620 of the glass. Components 440 of the LCD driver board assembly 420 are located on the portion 630 of the driver board assembly that protrudes below the edge 620 of the glass panel. The component portion of the driver board assembly need not traverse the entire width of the glass and can therefore be narrower than the width of the wider portion of the board. Accordingly, the portion of the driver board assembly that protrudes below the edge of the glass panel does not occupy the volume 460 of the panel assembly needed for the hinges. I.e., the T shape of the diver board defines spaces into which the hinges may be positioned.

This panel design allows the Y-dimension of the display assembly to be minimized to the dimension of the LCD glass plus the Y-dimension of the hinge volume. The display assembly thickness is only impacted by the 0.8 mm addition of the LCD driver board that traverses behind the glass panel 410.

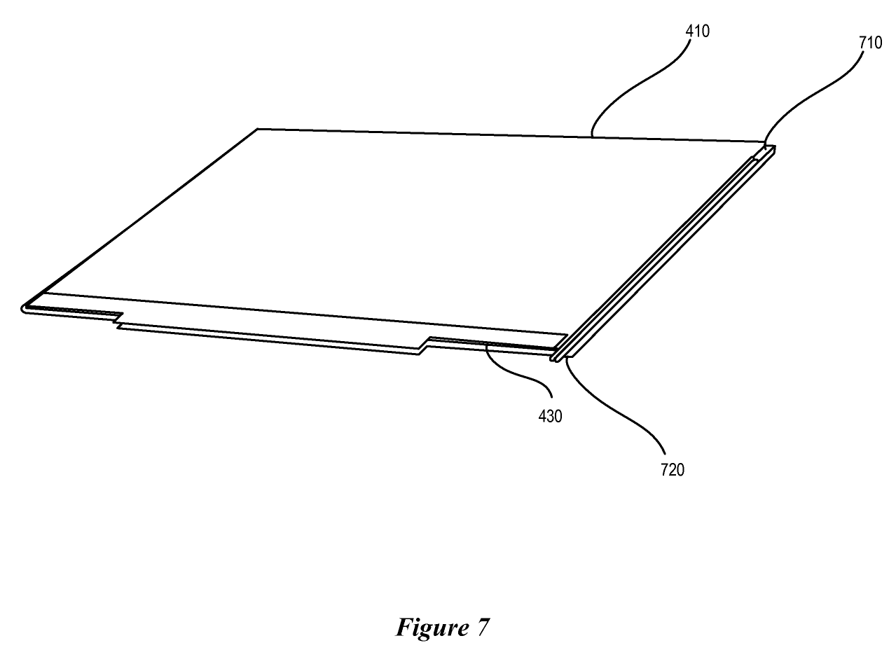

Referring to FIG. 7, a perspective view of an LCD panel assembly including a wire channel is shown. More specifically, a light guide that is placed behind the LCD glass is utilized to illuminate the active area of the LCD glass. Often, there is unused (i.e., dead space) around the perimeter of the LCD glass for electrical connections and sealing of the glass panels (in certain embodiments, this space is approximately 5 mm). In certain embodiments, the light guide is reduced in size by approximately 4 mm per side to create a channel 710 on the left and right sides of the panel 410. These channels can then be used for display assembly wire management.

Additionally, many notebook information handling systems have antennas positioned along the top edge of a display assembly. The wires that connect the antennas to the system base are coaxial wires that are 1.4 mm in diameter. The non-populated driver board that traverses behind the LCD panel is 0.8 mm thickness. The light guide has a thickness of approximately 1.2 mm. By decreasing the total width of the light guide, a wire channel with a depth of about 2 mm is created allowing for antenna wire runs 720 to the top edge of the display without affecting any of the display dimensions.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, in certain embodiments, the illumination LEDs may be mounted directly to the driver board 420. Right angle LEDs mounted to the component side of the driver board are in the correct orientation to illuminate the edge of the light guide that is placed behind the LCD glass 410.

Consequently, the invention is intended to be limited only by the spirit and scope of the appended claims, giving full cognizance to equivalents in all respects.

What is claimed is:

1. An information handling system display assembly comprising:
a display panel, the display panel having a width;
a display board assembly, the display board assembly being coupled to the display panel, the display board assembly comprising
a display board, the display board assembly being coupled to the display panel on a display panel side of the display board, the display board having a wider portion extending the substantially width of the display panel and a narrow portion extending less than the width of the display panel; and,
a display component, the display component being mounted on the display panel side of the display board.

2. The information handling system display assembly of claim 1 wherein:
the display panel comprises a depth; and,
when the display component is mounted on the display board, the display component protrudes no further than the depth of the display panel.

3. The information handling system display assembly of claim 1 wherein:
the display board corresponds to a T shape, the T shape having a top and a base; and,
the wider portion of the display panel corresponds to the top of the T shape and the narrower portion of the display panel corresponds to the base of the T shape.

4. The information handling system display assembly of claim 1 wherein:
the wider portion of the display board and the narrower portion of the display board are contiguous; and,
intersection of the wider portion of the display board and the narrower portion of the display board defines spaces into which hinges may be positioned.

5. The information handling system display assembly of claim 1 further comprising:
a display assembly housing, the display panel being mounted within the display assembly housing, the display assembly housing having a width, the width of the display assembly housing being greater than the width of the display panel and defining a channel; and wherein
an antenna is positioned within the channel.

6. The information handling system display assembly of claim 1 wherein:
the display panel comprises a liquid crystal display (LCD) panel.

7. An information handling system display assembly comprising:
a processor;
memory coupled to the processor; and,
a display assembly, the display assembly comprising
a display panel, the display panel having a width;
a display board assembly, the display board assembly being coupled to the processor and the display panel, the display board assembly comprising
a display board, the display board assembly being coupled to the display panel on a display panel side of the display board, the display board having a wider portion extending the substantially width of the display panel and a narrow portion extending less than the width of the display panel; and,
a display component, the display component being mounted on the display panel side of the display board.

8. The information handling system of claim 7 wherein:
the display panel comprises a depth; and,
when the display component is mounted on the display board, the display component protrudes no further than the depth of the display panel.

9. The information handling system of claim 7 wherein:
the display board corresponds to a T shape, the T shape having a top and a base; and,
the wider portion of the display panel corresponds to the top of the T shape and the narrower portion of the display panel corresponds to the base of the T shape.

10. The information handling system of claim 7 wherein:
the wider portion of the display board and the narrower portion of the display board are contiguous; and,
intersection of the wider portion of the display board and the narrower portion of the display board defines spaces into which hinges may be positioned.

11. The information handling system of claim 7 wherein the display assembly further comprises:
a display assembly housing, the display panel being mounted within the display assembly housing, the display assembly housing having a width, the width of the display assembly housing being greater than the width of the display panel and defining a channel; and wherein
an antenna is positioned within the channel.

12. The information handling system of claim 7 wherein:
the display panel comprises a liquid crystal display (LCD) panel.
